(19) United States
(12) Patent Application Publication
(10) Pub. No.: US 2014/0012520 A1
(43) Pub. Date: Jan. 9, 2014

(54) PHOTOVOLTAIC STRING MONITOR

(71) Applicants: Ye Zhao, Malden, MA (US); Peng Li, Marlborough, MA (US); Bradley Lehman, Belmont, MA (US); Gianfranco de Palma, Arlington, MA (US)

(72) Inventors: Ye Zhao, Malden, MA (US); Peng Li, Marlborough, MA (US); Bradley Lehman, Belmont, MA (US); Gianfranco de Palma, Arlington, MA (US)

(73) Assignees: Mersen USA Newburyport-MA, LLC; Northeastern University

(21) Appl. No.: 13/541,105

(22) Filed: Jul. 3, 2012

(51) Int. Cl. G06F 19/00; H02H 9/02

(52) U.S. Cl. 702/58; 702/64; 361/93.1

(57) ABSTRACT

A photovoltaic string monitor that provides PV-string level monitoring to detect abnormal operating conditions. The photovoltaic string monitor includes an indicator unit for indicating normal conditions, existing abnormal conditions or past occurrence of abnormal conditions. In one embodiment, the photovoltaic string monitor includes a plurality of lights and an LCD display.

### FIELD OF THE INVENTION

The present invention relates generally to the field of photovoltaic energy systems, and more particularly to a photovoltaic (PV) string monitor for providing string-level monitoring to indicate normal and abnormal (e.g., fault and mismatch) operating conditions.

### BACKGROUND OF THE INVENTION

One common type of installation for generating electricity from solar energy takes the form of a photovoltaic (PV) system with a centralized power conversion unit (e.g., PV converter or inverter). For a grid-connected PV system, the PV system is typically comprised of a large PV array that functions as a DC power-generating unit, a grid-connected DC-to-AC inverter, connection wirings and protection devices. For a stand-alone PV system (i.e., off-grid), the PV system is typically comprised of a large PV array that functions as a DC power-generating unit, a DC-to-DC converter, connection wirings; protection devices, and optional batteries.

The PV array is comprised of a plurality of PV modules that capture sunlight as direct current (DC). Typically, the PV modules are series-connected to form a PV string. A plurality of PV strings may be connected in parallel to form a PV array.

The grid-connected DC-to-AC inverter converts DC solar power from the PV array into AC current that is fed to a utility grid. The inverter includes a maximum power point tracker (MPPT) system to achieve maximum output power from the PV array. In a stand-alone PV system, the MPPT is within the DC-to-DC converter. The MPPT system samples the output of the PV modules and applies the proper resistance (load) to obtain maximum power for any given environmental condition. MPPT systems have three main types of MPPT algorithms, known as: perturb-and-observe, incremental conductance and constant voltage.

Circuit protection devices for the PV system may include overcurrent protection devices (OCPD) and ground fault protection devices (GFPD). One widely used overcurrent protection device is a fuse that is placed in series with each PV string to protect the PV modules and wiring connections of the PV system in the event of an overcurrent condition. Fuses are only able to clear faults and isolate faulty circuits if they carry a large fault current. However, due to the current-limiting nature and non-linear output characteristics of PV arrays, there can be “blind spots” in PV protection schemes that need special consideration. According to the U.S. National Electrical Code (NEC) requirement, fuses rated current (I_{N}) should be no less than 1.56 I_{SC}, where I_{SC} is the PV module's rated short-circuit current (I_{SC}) at standard test condition (STC). The minimum breaking capacity of fuses is usually 1.35 I_{N}. Therefore, to be able to melt the fuse, the fault current flowing through the fuse must be larger than 1.35*1.56 I_{SC}, which is approximately 2.1 I_{SC}.

Fuses are typically connected in a PV system by use of a fuse holder. The fuse holder includes a socket or holding element that allows convenient replacement of the fuse. Existing fuse holders may also include a “blown fuse” status indicator in order to provide users and/or maintenance personnel with notification of the fuse condition.

There are several disadvantages to such existing “blown fuse” status indicators. In this respect, these status indicators do not indicate the present status of individual PV strings, and thus do not facilitate determining the performance of each PV string in a PV array. Another disadvantage of existing status indicators is that they may fail when a fuse has actually blown (i.e., melted). For instance, existing status indicators may fail in circumstances, such as: (a) the voltage across the blown fuse is not high enough to turn on (i.e., activate) an indicator light of the status indicator, (b) low voltage conditions resulting from low irradiance or no irradiance (e.g., at night), or a (c) temporary fault that does not last long enough to melt the fuse. It is also noted that some fault conditions might exist in a PV array that do not cause the fuse to blow (i.e., melt). Since fuses are overcurrent protection devices that only melt according to their respective “current vs. melting time” characteristics, if a fault current passing through the fuse is not high enough or long enough, the fuse might not melt in response to the fault condition. As a result, the status indicator will not indicate any abnormal condition, and the fault in the PV array will remain “hidden.” In such cases, it is not possible to determine whether a fault condition currently exists or previously existed in a PV string by simply checking the “blown fuse” status indicator. It will be appreciated that a fault current may be smaller than expected for one of many reasons, such as, a line-line fault with a small voltage difference; reduction of the fault current by a MPPT; low irradiance (e.g., due to as cloudy day); or varying irradiance (e.g., due to “night-to-day” transition).

The present invention provides a PV string monitor that overcomes these and other drawbacks of existing status indicators.

### SUMMARY OF THE INVENTION

In accordance with the present invention, there is provided a photovoltaic string monitor for monitoring operating conditions of a photovoltaic (PV) string of a PV array, said string monitor comprising: (a) a sensor for sensing a current I_{PV} associated with the PV string and providing a signal indicative thereof; (b) an indicator unit having a plurality of operating modes indicative of different status conditions of the PV string, said status conditions classified by a plurality of decision boundaries, wherein at least one decision boundary has a negative value for the current I_{PV}; and (c) a control unit electrically connected to the sensor to receive a signal indicative of the current I_{PV} and electrically connected to the indicator unit.

An advantage of the present invention is the provision of a PV string monitor that provides fault detection and status indication at the PV string level;

Another advantage of the present invention is the provision of a PV string monitor that provides status information to facilitate locating a fault in a particular PV string(s) of a PV array.

Still another advantage of the present invention is the provision of a PV string monitor that monitors and indicates current level in an associated PV string.

Still another advantage of the present invention is the provision of a PV string monitor that expedites maintenance on a PV array and decreases mean time between failures (MTBF).

A still further advantage of the present invention is the provision of a PV string monitor that detects an often negative fault current in a PV string, captures the fault event, and provides an indication of an abnormal current level in the PV string.

A still further advantage of the present invention is the provision of a PV string monitor that is capable of transmitting a trigger signal to external circuits for fault clearance.

A still further advantage of the present invention is the provision of a PV string monitor that saves data indicative of an historical fault event that is not lost in the event of a power supply interruption.

Yet another advantage of the present invention is the provision of a PV string monitor that is compact, modular, low cost, and applicable to existing PV arrays.

Yet another advantage of the present invention is the provision of a PV string monitor that identifies the type of fault by communicating with ground fault protection devices (GFPD) in a PV system.

Yet another advantage of the present invention is the provision of a PV string monitor that can be powered by an external power supply, thereby operating independently of the solar irradiance level.

Yet another advantage of the present invention is the provision of a PV string monitor that can operate in connection with a variety of different types of overcurrent protection devices (e.g., fuses and circuit breakers).

Yet another advantage of the present invention is the provision of a PV string monitor wherein a single control unit may be shared with multiple PV string monitors.

Yet a further advantage of the present invention is the provision of a PV string monitor that includes a microcontroller that can receive data on-line and/or make adaptive adjustments to update decision boundaries for classifying status conditions.

These and other advantages will become apparent from the following description taken together with the accompanying drawings and the appended claims.

### BRIEF DESCRIPTION OF THE DRAWINGS

The invention may take physical form in certain parts and arrangement of parts, an embodiment of which will be described in detail in the specification and illustrated in the accompanying drawings which form a part hereof, and wherein:

FIG. 1 is a schematic diagram of a photovoltaic (PV) system that includes PV string monitors according to an embodiment of the present invention;

FIG. 1A is a schematic diagram of the PV system of FIG. 1 showing a ground fault in the first PV string of a PV array;

FIG. 1B is a schematic diagram of the PV system of FIG. 1 showing a line-line fault between the first and second PV strings 22 of the PV array;

FIG. 1C is a schematic diagram of a PV system having PV string monitors that share a single control unit.

FIG. 2 is a schematic diagram of the PV string monitor according to an embodiment of the present invention;

FIG. 3 is a flowchart illustrating an operating algorithm of the PV string monitor according to an embodiment of the present invention;

FIGS. 4, 5A-5B, 6A-6B, 7A-7B, 8A-8B, 9A-9B, 10A-10B, 11A-11B, 12A-12B, 13A-13B, 14A-14B, and 15A-15B illustrate operation of the indicator display of the PV string monitor of the present invention in response to various conditions.

### DETAILED DESCRIPTION OF THE INVENTION

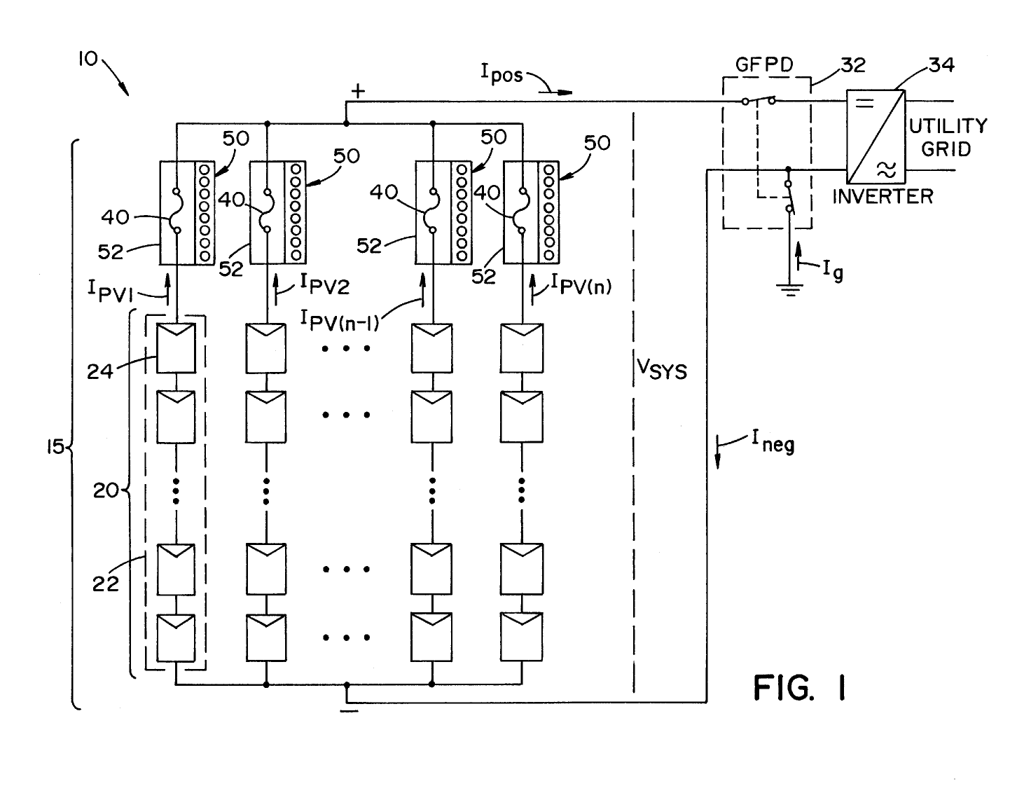

Referring now to the drawings wherein the showings are for the purposes of illustrating an embodiment of the invention only and not for the purposes of limiting same, FIG. 1 shows a photovoltaic (PV) system 10 generally comprised of a PV array 20 including a plurality of PV modules 24, a ground fault protection device (GFPD) 32, a grid-connected DC-to-AC inverter 34, a plurality of PV string monitors 50 according to an embodiment of the present invention, wherein each string monitor 50 is associated with a holding element 52 that holds a circuit protection device (e.g., a fuse 40), and connection wirings. It should be understood that according to some embodiments of the present invention, holding element 52 may be an integral part of string monitor 50 (e.g., forming a “smart fuse holder”), rather than a separate component electrically connected with string monitor 50. Furthermore, it is also contemplated that a circuit breaker or other circuit protection device may be substituted for holding element 52 and associated fuse 40. PV array 20 in combination with PV string monitors 50, holding elements 52, and the circuit protection devices are collectively referred to as a solar power generation unit 15.

PV modules 24 capture sunlight as direct current (DC), and are connected in series to form a PV string 22. PV strings 22 are connected in parallel to form PV array 20. In the embodiment illustrated in FIG. 1, each PV string 22 has an associated string monitor 50 and holding element 52, connected in series therewith, for holding a fuse 40. String monitor 50 detects fault and/or mismatch problems in PV array 20 and indicates PV string-level current levels, as will be described in detail below.

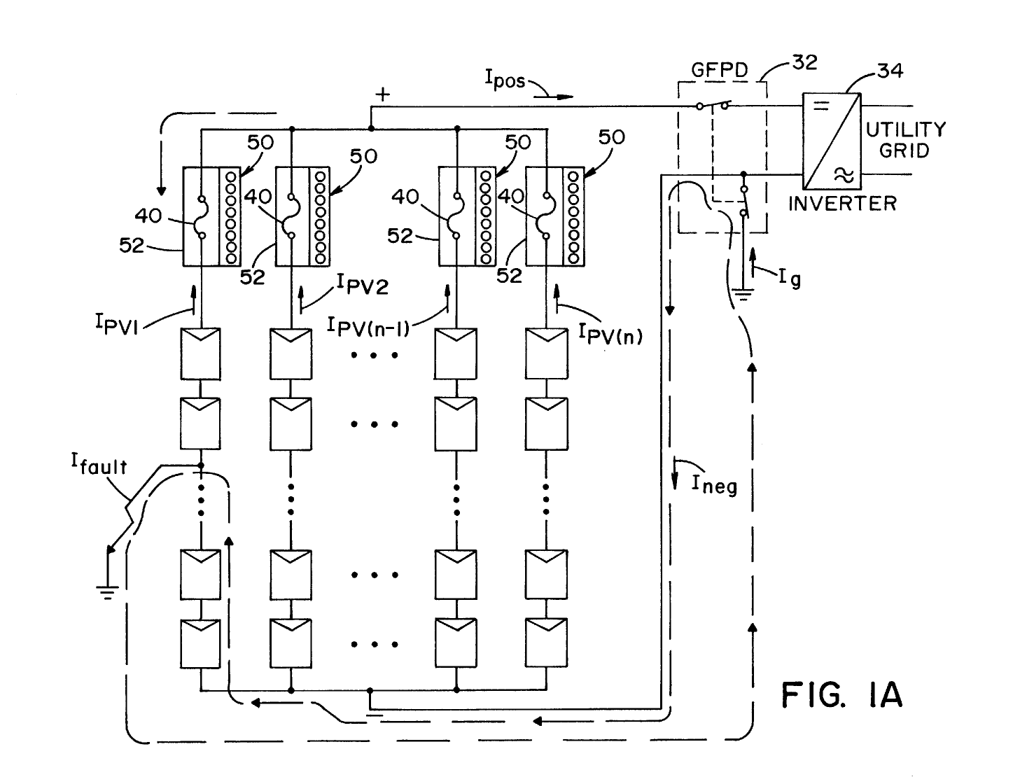

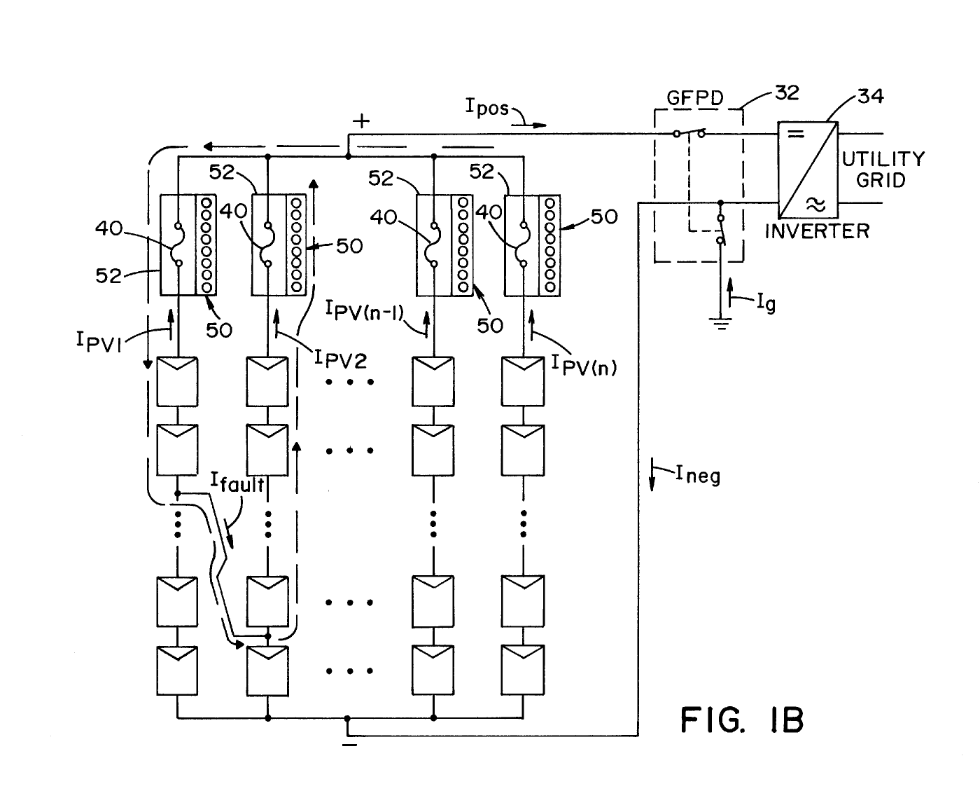

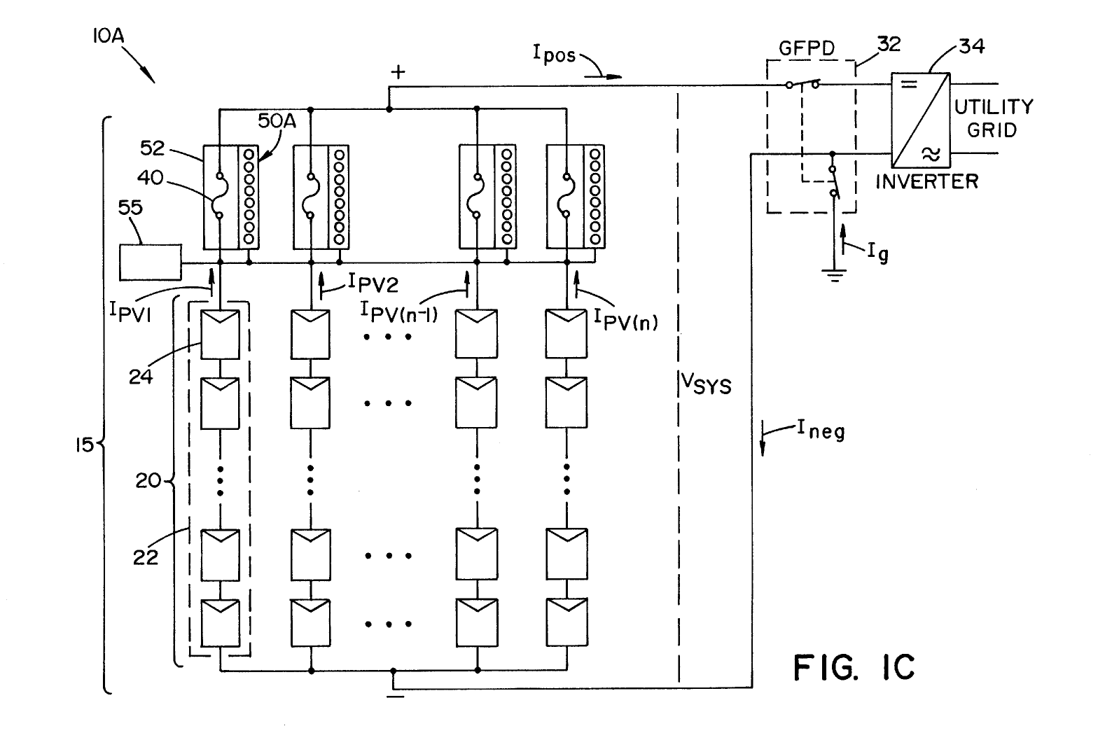

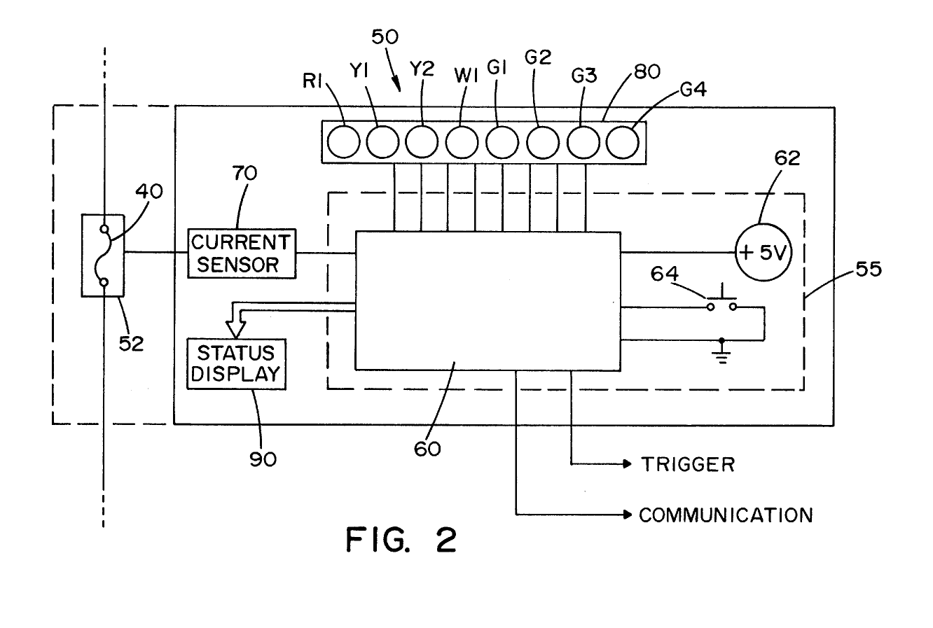

Referring now to FIG. 2, string monitor 50 may include, or be electrically connected with, a fuse holding element 52 (e.g., clips) that holds a fuse 40 (e.g., photovoltaic fuses, HP6J 600VDC from Mersen). String monitor 50 further comprises a control unit 55 that includes a microcontroller 60 powered by a 5V power supply 62 and a reset circuit 64 having a reset button for manually resetting microcontroller 60; a current sensor 70 for sensing the current passing through fuse 40 held by holding element 50; an indicator unit 80 for providing status information concerning associated PV string 22; and an optional display 90.

As mentioned above, in the illustrated embodiment microcontroller 60 is powered by a 5V power supply 62, which may take the form of a battery. Alternatively, microcontroller 60 could be “self-powered” by energy provided by PV modules 24.

Indicator unit 80 has a plurality of operating modes, wherein each operating mode is indicative of different status conditions of associated PV string 22 (e.g., fault, mismatch, zero current, and normal). In the illustrated embodiment, indicator unit 80 is comprised of a display unit having a plurality of colored lights, such as light emitting diodes (LEDs). More specifically, the plurality of LEDs are illustrated as follow: R1 (red), Y1 (yellow), Y2 (yellow), W1 (white), G1 (green), G2 (green), G3 (green) and G4 (green). Various combinations of lights are illuminated with respect to each operating mode of indicator unit 80. Indicator unit 80 is connected to a first I/O port of microcontroller 60.

The selected number of LEDs and the selected LED colors are for illustrative purposes only, and are not intended to limit the scope of the present invention. Furthermore, it is contemplated that indicator unit 80 may take different forms than as shown in the illustrated embodiment. For instance, indicator unit 80 may take the form of a text-based display and/or symbol/icon-based display unit. In this case, descriptive text and/or symbols/icons indicate different status conditions of associated PV string 22, wherein the display of various descriptive text and/or symbols/icons constitutes different operating modes of indicator unit 80. Moreover, it is further contemplated that indicator unit 80 may also include an audible indicator (e.g., sound alarm), or substitute the visual indicator (e.g., LEDs/LCDs) with an audible indicator. The audible indicator may have various sounds that constitute different operating modes of indicator unit 80.

Optional display 90 may take the form of an LCD display that displays descriptive text and/or icons associated with the status of the associated PV string 22. Display 90 is connected to a second I/O port of microcontroller 60.

Current sensor 70 may take the form of a variety of different current sensing devices, including, but not limited to, a hall-effect current sensor (e.g. ACS7XX series hall-effect current sensor from Allegro).

Microcontroller 60 preferably includes an on-board memory (e.g., EEPROM) and an analog-to-digital converter (ADC). Current sensor 70 provides an analog signal indicative of the current flowing through fuse 40. This analog signal is converted to a digital value by the ADC, and is subsequently used by microcontroller 60 to control the output signals sent to indicator unit 80 and display 90. Alternatively, a separate ADC chip or circuit can be provided to convert the analog signal to a digital signal. (e.g., 8-bit microcontroller PIC16P87XA from Microchip).

Microcontroller 60 may include a trigger signal line 66 connected to a third I/O port of microcontroller 60. Under fault conditions, microcontroller 60 may use trigger signal line 66 to transmit an optional “trigger” signal to an external circuit protection device to clear a fault.

Microcontroller 60 may also include a communication line 68 connected to a fourth I/O port of microcontroller 60. Communication line 68 is used to communicate with other devices, such as the ground fault protection devices (GFPD) 22 or equivalent devices. For example, GFPD 32 may transmit data to microcontroller 60 indicating whether GFPD 32 has detected a fault. If both string monitor 50 and GFPD 32 detect a fault, then string monitor 50 identifies the fault as a ground fault. If string monitor 50 detects a fault, but GFPD 32 does not detect a fault, then string monitor 50 identifies the fault as a line-line fault, without involving any ground-fault points. Once a fault condition is identified by string monitor 50, display 90 may show text of “line-line fault” or “ground fault.” Communication line 68 may also be used by microcontroller 60 for on-line communications for on-line updates, as will be discussed below.

FIG. 1C illustrates an alternative embodiment of the present invention, wherein a single control unit 55 is shared by a plurality of string monitors 50. In this embodiment, the single control unit 55 acts as a central controller.

Referring now to FIGS. 1, 1A, 1B and 1C, the current flowing toward the negative terminal of solar power generation unit 15 is labeled as I_{neg}, while the current flowing away from positive terminal of solar power generation unit 15 is labeled as Iₚₒₛ. The current flowing through each fuse 40 is the PV string current (I_{PV}) of the associated PV string 22. In FIG. 1, the respective PV string currents (I_{PV}) are labeled as I_{PV1}, I_{PV2} . . . I_{PV(n-1)} and I_{PV(n)}. The voltage supplied by solar power generation unit 15 is labeled as V_{SYS}.

The circuit components described above for string monitor 50 are solely for illustrating an embodiment of the present invention, and are not intended to limit same. In this respect, it should be understood that alternative circuit components may be substituted for the illustrated circuit components. For example, a custom control circuit functioning essentially the same as microcontroller 60 may be substituted for microcontroller 60.

The basic operation of string monitor 50 according to an embodiment of the present invention will now be described in detail. In general, string monitor 50 monitors the PV string current of an associated PV string 22, detects the occurrence of abnormal conditions (e.g., fault, mismatch and zero current conditions), and provides an indication of the status of the PV string current.

Current sensor 70 detects the amount of current I_{PV} flowing in the associated fuse 40. An analog signal indicative of the amount of current I_{PV} is provided to microcontroller 60. Microcontroller 60 converts the analog signal to a digital value, and according to the level of current I_{PV}, microcontroller 60 illuminates selected LEDs of indicator unit 80 in accordance with a predefined algorithm. By observing the LEDs of indicator unit 80, maintenance personnel can readily determine the performance of each PV string 22.

As shown in TABLE 1 below, the status of the PV string current I_{PV} of PV string 22 has four (4) possible statuses: fault, mismatch, zero current and normal. The values α₁, β₁ and β₂ are constants referred to herein as “indication parameters.” The indication parameters define decision boundaries for classifying status conditions. It should be appreciated that one or more decision boundaries may have a negative value for I_{PV}, as illustrated in TABLE 1.

TABLE 1

| | | | | |
|---|---|---|---|---|
| PV string | I_{PV} < −α₁I_{SC} | −α₁I_{SC} ≦ I_{PV} ≦ −β₁I_{SC} | −β₁I_{SC} < I_{PV} < β₂I_{SC} | β₂I_{SC} ≦ I_{PV} |
| current (I_{PV}) | | | | |
| Status | Fault | Mismatch | Zero current | Normal |
| Condition | | | | |
| Possible | Faults in the | Faults in the PV | Blown fuse; Open- | Post-fault steady |
| Conditions: | PV string | string; or | circuit fault; or | state; |
| | (large backfed | Mismatch problem | nighttime | Post-mismatch |
| | current). | (small backfed | conditions (no | steady state; |
| | | current). | irradiance). | No fault; No |
| | | | | Mismatch; or No |
| | | | | Zero current. |
| | | | | (PV current is |
| | | | | presently |
| | | | | positive) |
| Fuse protection | Yes | No | No | No |
| will work? | | | | |

| | |
|---|---|
| Fault effects | Large amount of power losses; potential fire hazards and personnel safety issues |
| on PV array | |

A “fault” status occurs when a large backfed PV string current (negative) I_{PV} flows into a PV string 22 as a result of a fault condition associated with the PV string 22. More specifically, the fault in PV string 22 could be a ground fault (FIG. 1A) or a line-line fault (FIG. 1B) between multiple PV strings 22. In the illustrated embodiment, a fault status is detected when I_{PV}<−α₁I_{SC}. As an example, a typical value for α₁=2.1. One reason for selecting a typical α₁ as 2.1 is that the minimum breaking capacity (I_{min-break}) of fuses is often rated at 1.35 I_{N}, according to UL standard 2579-7, where I_{N} is the fuse current rating, and I_{N} is usually 1.56 I_{SC} according to the US National Electrical Code (NEC) requirement. Therefore, I_{min-break} of PV fuses must be larger than 2.1 I_{SC} (=1.35*1.56 I_{SC}). If I_{PV} is less than −α₁I_{SC} for a long enough time period, according to the “melting time vs. current” characteristic of fuse 40, then fuse 40 will be properly melted. Line-line fault refers to an accidental low-resistance connection established between two points of different potential in a PV array.

A “mismatch” status occurs when a small backfed PV string current (negative) I_{PV} flows into a PV string 22 as a result of a fault in the PV string or a mismatch condition, such as partial shadings, or degradations on certain PV modules 24. Generally, mismatches occur when the electrical parameters of one or more PV modules 24 of a PV string 22 are significantly changed from those of other PV modules 24 of the PV string 22. In the illustrated embodiment, a mismatch status is detected when I_{PV} is negative and −α₁I_{SC}≦I_{PV}≦−β₁I_{SC}. As an example, typical values are α₁=2.1 and β₁=0.1. One reason for selecting a typical β₁ as 0.1 is that under low irradiance (e.g., about 100 W/m² in sunset), the short-circuit current of PV array 20 is only about 0.1 I_{SC}, which is small enough to be approximated as zero current.

A “zero current” status occurs when the PV string current I_{PV} has a very small magnitude or is zero. In the illustrated embodiment, a zero current status is detected when −β₁I_{SC}<I_{PV}<β₂I_{SC}, where β₁ and β₂ may be selected as small positive values. A zero current condition can be caused by a blown fuse, an open-circuit fault, nighttime conditions (no irradiance), sunrise or sunset conditions (low irradiance), or removal of a fuse 40 from a holding element 52.

A “normal” status occurs when the PV string current is positive. In the illustrated embodiment, a normal current status is detected when β₂I_{SC}≦I_{PV}. It should be appreciated that even if the foregoing condition is currently being met, there still might be an undetected problem at the PV string 22. For example, the PV string 22 might be at a “post-fault” steady state condition, or a “post-mismatch” steady state condition. String monitor 50 of the present invention detects the occurrence of an abnormal condition at a specific PV string 22, and provides an indication of such abnormal condition even after the condition returns to a “post-fault” steady state. Consequently, maintenance personnel can be alerted to the existence of the problem.

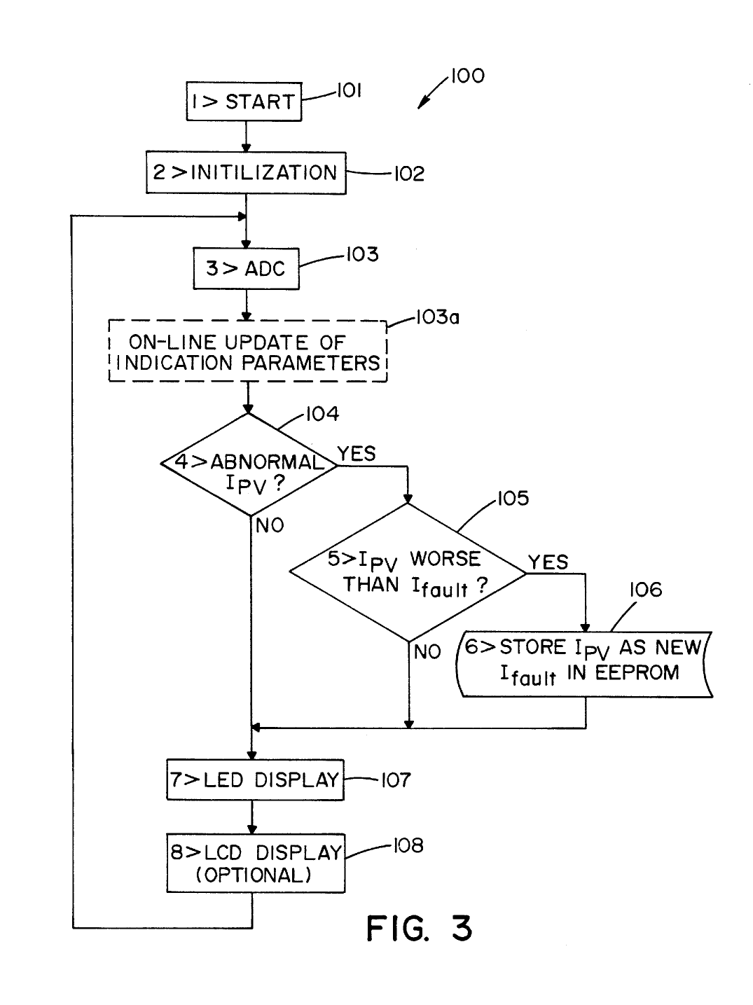

Referring now to FIG. 3, there is shown a flowchart of an algorithm 100 programmed into microcontroller 60. Algorithm 100 begins at step 101. At step 102, I/O port(s), on-board ADC, and internal timer of microcontroller 60 are initialized. Optional display 90 (e.g., LCD) may also be initialized at this time.

Analog-to-digital conversion occurs at step 103. In this respect, current sensor 70 measures the PV string current I_{PV} of the associated PV string 22, and provides an analog signal indicative of the PV string current I_{PV} to microcontroller 60. The on-board ADC converts this analog signal to a digital value. At optional step 103a, the decision boundaries (e.g., defined by indication parameters α₁, α₂, and β₁ to β₅, see TABLE 2 below) are updated on-line for fault detection (e.g., via communication line 68). The optional on-line updates may respond to changing environmental conditions, such as irradiance, temperature, wind, etc. For example, when there is high irradiance, then α₁, α₂, and β₁ to β₅ may be larger values than when there is lower irradiance. When there is no updating step 103a, fixed predetermined values for α₁, α₂, and β₁ to β₅ are programmed into microcontroller 60. Next, at step 104, if microcontroller 60 determines that I_{PV}≦−α₁I_{SC}, then microcontroller 60 detects an abnormal PV string current I_{PV} (i.e., a fault).

It should be appreciated that string monitor 50 may also be programmed to make adaptive adjustments to update the decision boundaries for classifying status conditions.

Microcontroller 60 also maintains a historic fault record. In this respect, the historic worst fault current (largest magnitude), referred to as I_{fault}, is recorded in the on-board memory (i.e., EEPROM) of microcontroller 60. I_{fault} is initially set to zero.

If no abnormal PV string current I_{PV} is detected, then the stored I_{fault} remains zero. If an abnormal PV string current I_{PV} is detected, then I_{PV} is compared with the currently stored I_{fault} (step 105). If I_{PV} is worse (i.e., larger magnitude) than the currently stored I_{fault}, then microcontroller 60 stores I_{PV} as the new I_{fault} (step 106).

At step 107 microcontroller 60 determines the status condition of the PV string current I_{PV} according to the described above in TABLE 1, and illuminates (e.g., turn on or blink) appropriate LEDs of indicator unit 80, as will be described in detail below. According to the status of the PV string current I_{PV}, the LCD of optional display 90 can be used display text and/or icons indicative of the status condition of the associated PV string 22 (e.g., fault, mismatch, zero current or normal). Display 90 may also be used to display the historic worst fault current I_{fault}.

I_{fault} remains stored in the EEPROM when microcontroller 60 is powered off. If reset circuit 64 is activated by manually pressing the reset button, the historic worst fault current I_{fault} stored in EEPROM is deleted by resetting I_{fault} to zero.

It should be noted that the processing functions, such as ADC, timer for LED blinking, and “reset button” can be implemented using “ADC interruption,” “timer interruption” and “external interruption” respectively in microcontroller 60.

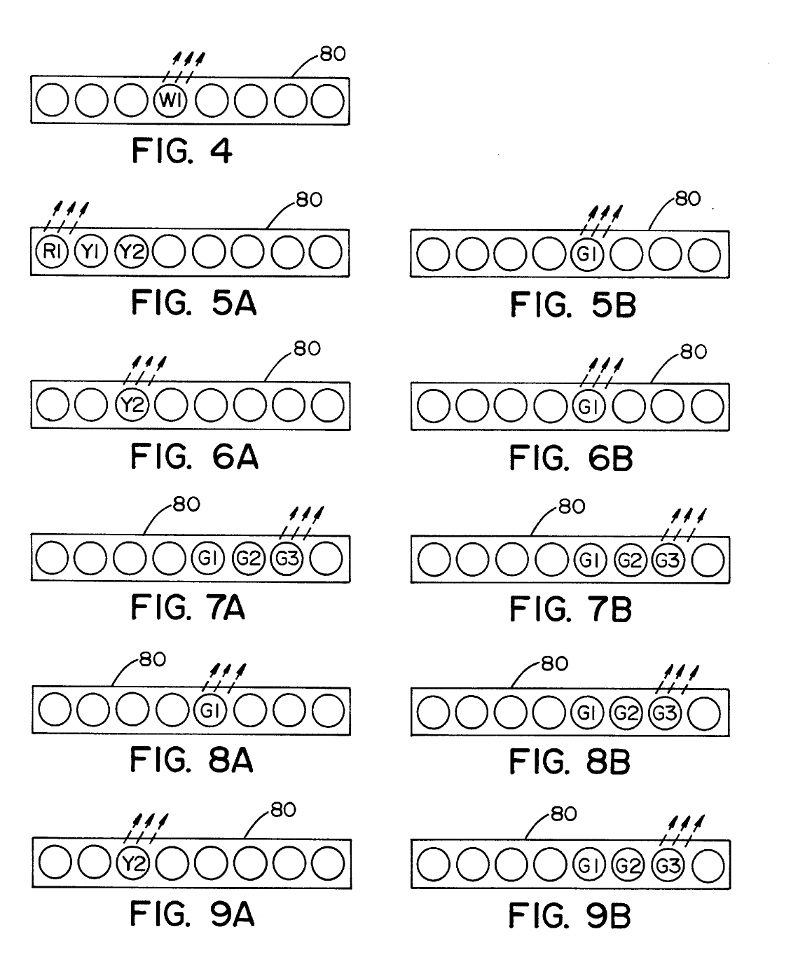

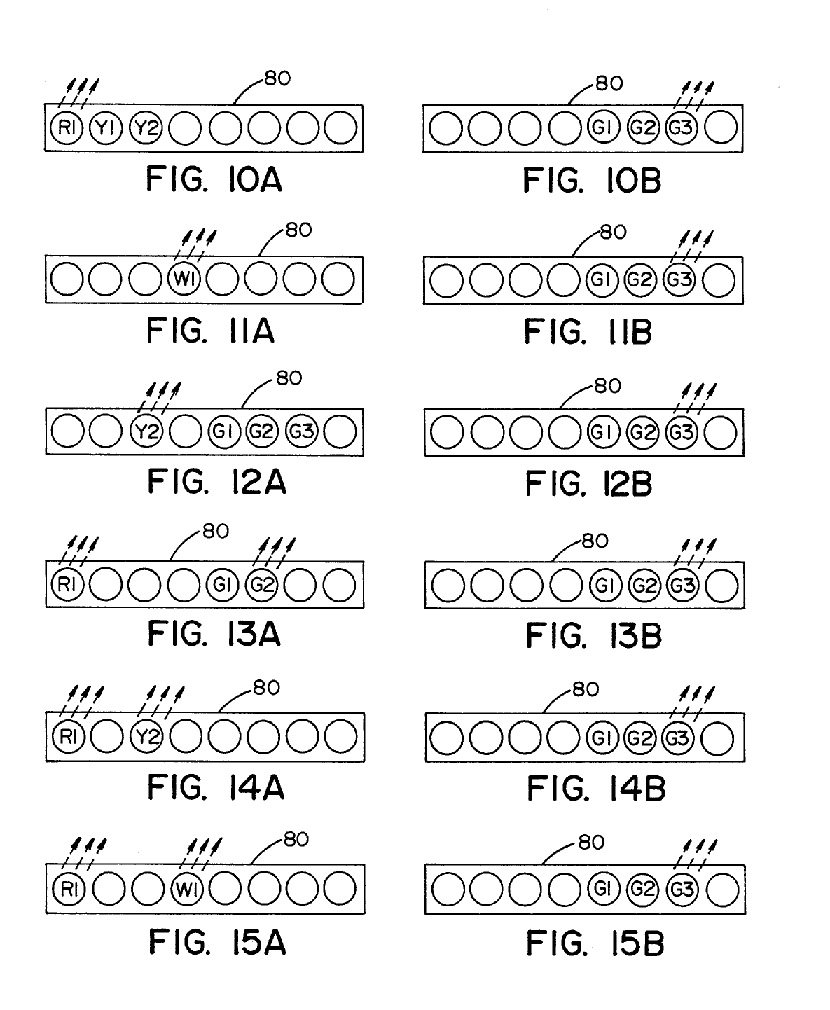

Operation of indicator unit 80 according to one embodiment of the present invention will now be described in detail with reference to TABLE 2 (below) and FIGS. 4, 5A-5B, 6A-6B, 7A-7B, 8A-8B, 9A-9B, 10A-10B, 11A-11B, 12A-12B, 13A-13B, 14A-14B, and 15A-15B. Indicator unit 80 provides an indication of the four (4) status conditions for PV string current I_{PV} (i.e., fault, mismatch, zero current and normal), as described in TABLE 2 below. The PV string current (I_{PV}) ranges for the various status conditions are established by a plurality of decision boundaries defined by indicator parameters. In the illustrated embodiment, indicator unit 80 is comprised of eight (8) colored LEDs. As shown in FIG. 2, from left to right, the eight (8) LEDs are identified as R1, Y1, Y2, W1, G1, G2, G3 and G4, respectively. Combinations of these LEDs are illuminated to indicate the present PV string current I_{PV}, as well as the occurrence of a fault or mismatch condition. To avoid unstable LED indication between the boundaries of different status conditions, a Schmitt Trigger and hysteresis may be added to the program in microcontroller 60. TABLE 2 summarizes the LED illuminations of indicator unit 80 in response to various status conditions.

TABLE 2

| | | | | |
|---|---|---|---|---|
| PV string | I_{PV} < −α₁I_{SC} | −α₁I_{SC} ≦ I_{PV} ≦ −β₁I_{SC} | −β₁I_{SC} < I_{PV} < β₂I_{SC} | β₂I_{SC} ≦ I_{PV} |
| current (I_{PV}) | | | | |
| Status | Fault | Mismatch | Zero current | Normal |
| Condition | | | | |
| Indication of | R1 is blinking | If −α₁I_{SC} ≦ I_{PV} < −α₂I_{SC}, | W1 is blinking at f1. | If β₂I_{SC} ≦ I_{PV} ≦ β₃I_{SC}, |
| present PV | (at f2), Y1 and | Y1 is blinking at f1, Y2 | | G1 is blinking at f1, |
| string current | Y2 are always | is on, and, others are | | others are off. |
| I_{PV} | on. | off. | | If β₃I_{SC} < I_{PV} ≦ β₄I_{SC}, |
| (f1 and f2 are | | | | G2 is blinking at f1, |
| blinking | | | | G1 is on, and others |
| frequency, | | | | are off. |
| where f1 < f2) | | If −α₂I_{SC} ≦ I_{PV} ≦ −β₁I_{SC}, | | If β₄I_{SC} < I_{PV} ≦ β₅I_{SC}, |
| | | Y2 is blinking at f1, | | G3 is blinking at f1, |
| | | others are off. | | G1 and G2 are on, and |
| | | | | others are off. |
| | | | | If β₅I_{SC} < I_{PV}, G4 is |
| | | | | blinking at f1, G1, G2 |
| | | | | and G3 are on, and |
| | | | | others are off. |

| | |
|---|---|
| Indication of | If “Fault” or “Mismatch” condition occurs, and the present I_{PV} has a smaller magnitude |
| historic worst | than the historic worst fault current I_{fault}, then I_{fault} remains the same. The indication of fault |
| fault current | status follows the corresponding rule described in TABLE 2. |
| I_{fault} | If “Fault” condition has occurred, and the present Iₚᵥ has a larger magnitude than the |
| | historic worst fault current, then I_{fault} will be replaced with the present Iₚᵥ. The indication is |
| | that R1 is blinking at frequency f2, Y1 and Y2 are always on. |
| | If “Mismatch” condition occurs, and the present Iₚᵥ has a larger magnitude than the historic |
| | worst fault current, then I_{fault} will be replaced with the present Iₚᵥ. The indication of fault |
| | status follows the corresponding rule described in TABLE 2. |

The values α₁, α₂ and β₁ to β₅ are indication parameters that define the decision boundaries for classifying status conditions. It should be appreciated that one or more decision boundaries may have a negative value for I_{PV}, as illustrated in TABLE 2.

PV array 20 is comprised of PV modules 24 with non-linear electrical behavior. PV array 20 performs differently when PV system 10 is in a “not working” mode as compared to when PV system 10 is in a “working” mode. Operation of indicator unit 80 will now be described wherein PV system 10 is in a “not working” mode and wherein PV system 10 is in a “working” mode.

PV system 10 may be in a “not working” condition due to such reasons as PV array 20 has been manually switched out for maintenance; inverter 34 has shut down; or the irradiance level is not high enough to turn on inverter 34 (e.g., during sunrise). In such cases, PV array 20 has an open-circuit status, resulting in the maximum voltage (V_{SYS}) at given weather condition, but zero current for PV array 20. In this situation, if no fault occurs, then each PV string current I_{PV} will ideally be zero. For an open-circuit condition, the indicator unit 80 associated with all of the PV strings 22 illuminate only a blinking LED W1, as shown in FIG. 4.

In a “not working” mode of the PV system, if a fault occurs at the first PV string 22 (having associated PV string current I_{PV1}), or the first PV string 22 has a severe aging/shading problem, then the first PV string 22 may become unbalanced with the other PV strings 22. As a result, the other PV string currents (I_{PV2} through I_{PV(n)}) may backfeed into the first PV string 22 and PV string current I_{PV1} may become negative. For the above-described circuit condition, the indicator unit 80 associated with the first PV string 22 illuminates R1-BLINKING/Y1-ON/Y2-ON (indicating a “fault” status), Y1-BLINKING/Y2-ON (indicating a “mismatch” status) or Y2-BLINKING (indicating a “mismatch” status). The respective indicator displays 80 associated with the other PV strings 22 illuminate G1-BLINKING, G1-ON/G2-BLINKING, G1-ON/G2-ON/G3-BLINKING or G1-ON/G2-ON/G3-ON/G4-BLINKING (all of which indicate a “normal” status).

More specifically, if a fault occurs at the first PV string 22, then the first PV string 22 may have a large negative (backfed) current (i.e., I_{PV1}<−α₁I_{SC}), while the other PV strings 22 may have a small positive current. Therefore, indicator unit 80 for the first PV string 22 illuminates R1-BLINKING/Y1-ON/Y2-ON (FIG. 5A) indicating a “fault” status, and the respective indicator displays 80 for the other PV strings 22 illuminate G1-BLINKING (FIG. 5B) indicating a “normal” status.

In another case, an aging problem may occur at the first PV string 22. Therefore, first PV string 22 may have small negative (backfed) current (−α₁I_{SC}≦I_{PV}≦−β₁I_{SC}) and the remaining PV strings 22 may have small positive current. Therefore, indicator unit 80 for the first PV string 22 illuminates Y2-BLINKING (FIG. 6A) indicating a “mismatch” status, and the respective indicator displays 80 for the other PV strings 22 illuminate G1-BLINKING (FIG. 6B) indicating a “normal” status.

The following examples are described with reference to a PV system 10 in a “working” mode. When PV system 10 is in a “working” mode PV array 20, the grid-connected inverter 34 and its MPPT system are also working. With the help of the MPPT system, PV array 20 operates around its maximum power point (MPP) and feeds electricity into a utility grid via inverter 34. If there is no fault occurring at the first PV string 22, indicator unit 80 for the first PV string 22 and the respective indicator displays 80 for the other PV strings 22 illuminate the LEDs to indicate a “normal” status, as defined in TABLE 2. For example, FIG. 7A shows the indicator unit 80 for the first PV string 22 illuminating G1-ON/G2-ON/G3-BLINKING, indicating the “normal” status associated with a positive PV string current. FIG. 7B shows the respective indicator unit 80 for the other PV strings 22 also illuminating G1-ON/G2-ON/G3-BLINKING indicating the “normal” status.

If there is some aging or shading problem at the first PV string 22, the associated PV string current I_{PV1} could be much smaller than the other PV string currents I_{PV2} through I_{PV(n)}. This problem can be readily recognized by comparing indicator unit 80 for the first PV string 22 (FIG. 8A) to respective indicator displays 80 for the other PV strings 22 (FIG. 8B). FIG. 8A shows an indicator unit 80 that indicates a “normal” status with a relatively small PV string current (β₂I_{SC}≦I_{PV}≦β₃I_{SC}) while FIG. 8B shows an indicator unit 80 that indicates a “normal” status with a relatively large PV string current (β₄I_{SC}<I_{PV}≦β₅I_{SC}). Typical values for the indication parameters may be as follows: βhd 1=0.1, β₂=0.1, β₃=0.35, β₄=0.6, β₅=0.85. By selecting these typical values, the positive-current conditions of I_{PV} are approximately evenly divided into several sub-conditions.

If a mismatch condition occurs at the first PV string 22, indicator unit 80 for the first PV string 22 illuminates the LEDs to indicate a “mismatch” status (FIG. 9A) according to TABLE 2, while the respective indicator displays 80 for the other PV strings 22 illuminate their LEDs to indicate a “normal” status (FIG. 9B) according to TABLE 2.

If a fault condition occurs at the first PV string 22, indicator unit 80 for the first PV string 22 illuminates the LEDs to indicate a “fault” status (FIG. 10A) according to TABLE 2, while the respective indicator displays 80 for the other PV strings 22 illuminate their LEDs to indicate a “normal” status (FIG. 10B) according to TABLE 2.

If the first PV string 22 is open-circuited—(e.g., due to a blown fuse or an open-circuit fault), indicator unit 80 for the first PV string 22 illuminates the LEDs to indicate a “zero current” status (FIG. 11A) according to TABLE 2, while the respective indicator displays 80 for the other PV strings 22 illuminate their LEDs to indicate a “normal” status (FIG. 11B) according to TABLE 2.

Referring now to FIGS. 12A and 12B, a “mismatch” occurs at the first PV string 22 and PV string current I_{PV1} of first PV string 22 is stored as I_{fault} in the EEPROM of microcontroller 60. With the help of the MPPT system of inverter 34, PV string current I_{PV1} becomes positive again, thereby ending the mismatch condition. Since there has been a “mismatch” condition at the first PV string 22, indicator unit 80 for the first PV string 22 illuminates Y2-BLINKING to indicate the occurrence of a “mismatch” condition (FIG. 12A) and simultaneously illuminates G1-ON/G2-ON/G3-BLINKING to indicate that PV string current I_{PV} is currently positive (“normal” status), as a result of the action taken by the MPPT system. The indicator unit 80 for the other PV strings 22 illuminates the LEDs to indicate a “normal” status (FIG. 12B).

Referring now to FIGS. 13A and 13B, a “fault” occurs at the first PV string 22 and PV string current I_{PV1} of first PV string 22 is stored as I_{fault} in the EEPROM of microcontroller 60. I_{fauit} may be quickly reduced by the MPPT of inverter 34 so that the fault cannot be detected or cleared by fuses. With the help of the MPPT system of inverter 34, PV string current I_{PV1} becomes positive again, thereby ending the “fault” condition. In this case, the “fault” condition does not last long enough to melt fuse 40. Therefore, indicator unit 80 for the first PV string 22 illuminates R1-BLINKING to indicate the occurrence of a “fault” condition, and simultaneously illuminates G1-ON/G2-BLINKING to indicate that PV string current I_{PV1} is currently positive (FIG. 13A). The indicator unit 80 for the other PV strings 22 illuminates the LEDs to indicate a “normal” status (FIG. 13B).

With reference to FIGS. 14A and 14B, a “fault” occurs at the first PV string 22 and PV string current I_{PV1} of first PV string 22 is stored as I_{fault} in the EEPROM of microcontroller 60. With the help of the MPPT system of inverter 34, the magnitude of PV string current I_{PV1} becomes smaller than I_{fault}. In this case, the “fault” condition does not last long enough to melt fuse 40. Therefore, indicator unit 80 for the first PV string 22 illuminates R1-BLINKING to indicate the occurrence of a “fault” condition, and simultaneously illuminates Y2-BLINKING to indicate that PV string current I_{PV1} is currently a small negative (FIG. 14A). The indicator unit 80 for the other PV strings 22 illuminates the LEDs to indicate a “normal” status (FIG. 14B).

With reference to FIGS. 15A and 15B, a “fault” occurs at the first PV string 22 and PV string current I_{PV1} of first PV string 22 is stored as I_{fault} in the EEPROM of microcontroller 60. In this case, fuse 40 melts due to the PV string current I_{PV1}. Therefore, indicator unit 80 for the first PV string 22 illuminates R1-BLINKING to indicate the occurrence of a “fault” condition, and simultaneously illuminates W1-BLINKING to indicate that PV string current I_{PV1} is currently around zero (FIG. 15A), as a result of the melted fuse 40. The indicator unit 80 for the other PV strings 22 illuminates the LEDs to indicate a “normal” status (FIG. 15B).

I_{fault} (i.e., the worst backfed PV string current) is maintained in the EEPROM of microcontroller 60 until reset button of reset circuit 64 is manually depressed. Activation of the reset circuit resets (i.e., reinitializes) I_{fault} to zero and clears indicator unit 80.

It should be appreciated that the multiple decision boundaries defined by the indication parameters (i.e., α₁, α₂, and β₁, to β₅; see TABLE 2) are not unique and are subject to change according to specific PV installations and environmental conditions. Accordingly, the indication parameter values disclosed herein are provided solely to illustrate the present invention, and not to limit same. One advantage of the present invention is that the indication parameters defining the decision boundaries can be updated on-line (e.g., via communication line 68), as shown at step 103a of FIG. 3. Therefore, the PV array's degradation or aging effects over time can be taken into consideration in the updates.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A photovoltaic string monitor for monitoring operating conditions of a photovoltaic (PV) string of a PV array, said string monitor comprising:
a sensor for sensing a current I_{PV} associated with the PV string and providing a signal indicative thereof;
an indicator unit having a plurality of operating modes indicative of different status conditions of the PV string, said status conditions classified by a plurality of decision boundaries, wherein at least one decision boundary has a negative value for the current I_{PV}; and
a control unit electrically connected to the sensor to receive a signal indicative of the current I_{PV} and electrically connected to the indicator unit.

2. A photovoltaic string monitor according to claim 1, wherein the string monitor further comprises:
a holding element for holding a fuse associated with the PV string of the PV array.

3. A photovoltaic string monitor according to claim 1, wherein said photovoltaic string monitor is electrically connected with an overcurrent protection device associated with the PV string of the PV array.

4. A photovoltaic string monitor according to claim 3, wherein said overcurrent protection device is a fuse or a circuit breaker.

5. A photovoltaic string monitor according to claim 1, wherein said string monitor provides an audible or visual indication of an abnormal condition.

6. A photovoltaic string monitor according to claim 1, wherein said control unit transmits a trigger signal to trigger an external circuit protection device to clear a fault.

7. A photovoltaic string monitor according to claim 1, wherein said photovoltaic string monitor detects faults that are temporary or due to low current faults.

8. A photovoltaic string monitor according to claim 1, wherein said indicator unit is a display unit.

9. A photovoltaic string monitor according to claim 8, wherein said display unit is comprised of a plurality of lights, wherein one or more lights are illuminated for each of said plurality of operating modes.

10. A photovoltaic string monitor according to claim 1, wherein said indicator unit is a text-based display unit.

11. A photovoltaic string monitor according to claim 1, wherein said indicator unit is a symbol/icon-based display unit.

12. A photovoltaic string monitor according to claim 1, wherein said photovoltaic string monitor further comprises a reset circuit for manually resetting said control unit.

13. A photovoltaic string monitor according to claim 1, wherein said photovoltaic string monitor further comprises a power supply for supplying power to said control unit.

14. A photovoltaic string monitor according to claim 1, wherein said control unit is programmed to analyze current I_{PV} to determine one of a plurality of status conditions of the PV string, said control unit activating the indicator unit in an operating mode indicative of the determined status condition.

15. A photovoltaic string monitor according to claim 14, wherein said plurality of status conditions of the PV string include: fault, mismatch, zero current and normal.

16. A photovoltaic string monitor according to claim 15, wherein said fault status condition is determined if I_{PV}<−α₁I_{SC}, where I_{SC} is the rated short-circuit current of a photovoltaic (PV) module that comprises the PV string and α₁ is an indication parameter.

17. A photovoltaic string monitor according to claim 16, wherein α₁ can be changed by an on-line update.

18. A photovoltaic string monitor according to claim 15, wherein said mismatch status condition is determined if −α₁I_{SC}≦I_{PV}≦−β₁I_{SC}, where I_{SC} is the rated short-circuit current of a photovoltaic (PV) module that comprises the PV string and α₁ and β₁ are indication parameters.

19. A photovoltaic string monitor according to claim 18, wherein α₁ and β₁ can be changed by an on-line update.

20. A photovoltaic string monitor according to claim 15, wherein said zero current status condition is determined if −β₁I_{SC}<I_{PV}<β₂I_{SC}, where I_{SC} is the rated short-circuit current of a photovoltaic (PV) module that comprises the PV string and β₁ and β₂ are indication parameters.

21. A photovoltaic string monitor according to claim 20, wherein β₁ and β₂ can be changed by an on-line update.

22. A photovoltaic string monitor according to claim 15, wherein said normal status condition is determined if β₂I_{SC}≦I_{PV}≦β₅I_{SC}, where I_{SC} is the rated short-circuit current of a photovoltaic (PV) module that comprises the PV string and β₁ to β₅ are indication parameters.

23. A photovoltaic string monitor according to claim 22, wherein β₁ to β₅ can be changed by an on-line update.

24. A photovoltaic string monitor according to claim 1, wherein said control unit updates the decision boundaries for classifying the status conditions, in response to changing environmental conditions.

25. A photovoltaic string monitor according to claim 15, wherein said control unit includes memory for storing a value of a historic worst fault current I_{fault}, wherein said value for I_{fault} is initialized to zero and is replaced with a new I_{fault} when a fault status condition is determined and I_{PV} is greater than currently stored I_{fault}.

26. A photovoltaic string monitor according to claim 25, wherein activation of a reset circuit re-initializes I_{fault} stored in the memory of the control unit.

27. A photovoltaic string monitor according to claim 1, wherein said photovoltaic string monitor includes a communication line to communicate with a ground fault protection device.

28. A photovoltaic string monitor according to claim 27, wherein said control unit distinguishes between a ground fault and a line-line fault by communicating with the ground fault protection device.

29. A photovoltaic string monitor according to claim 1, wherein said photovoltaic string monitor is connectable with a grid-connected PV system or a stand-alone PV system.
